(19) United States
(12) Patent Application Publication
(10) Pub. No.: US 2009/0012647 A1
(43) Pub. Date: Jan. 8, 2009

(54) Robot system employing multijoint robots and workpiece delivery method

(75) Inventor: Koji Kamiya, Anjo-shi (JP)

Correspondence Address: OLIFF & BERRIDGE, PLC, P.O. BOX 320850, ALEXANDRIA, VA, 22320-4850, US

(73) Assignee: DENSO WAVE INCORPORATED, TOKYO (JP)

(21) Appl. No.: 12/216,507

(22) Filed: Jul. 7, 2008

(30) Foreign Application Priority Data
Jul. 5, 2007 (JP) 2007-177387

(51) Int. Cl. G05B 19/418

(52) U.S. Cl. 700/248; 700/262; 901/50

(57) ABSTRACT

A multijoint robot has a multijoint link and a hand attached to the link. The robot comprises motion separating means and control means. The motion separating means separates, in terms of vectors, a motion of the hand into a first motional vector component along a given plane and a second motional vector component along a plane perpendicular to the given plane. The control means controls a motion of the hand based on an operation timing of the hand to be set on the first motional vector component and the second motional vector component.

### CROSS REFERENCES TO RELATED APPLICATIONS

The present application relates to and incorporates by reference Japanese Patent Application No. 2007-177387 filed on Jul. 5, 2007.

### BACKGROUND OF THE INVENTION

1. Field of the Invention

The present invention relates to a robot system employing multijoint robots and workpiece delivery method, which is able to divide a single motion into a motion in a single plane and a motion in a direction perpendicular to the plane.

2. Description of the Related Art

Multijoint robots have a plurality of joints and are adapted to realize a desired motion combining the motion of each of the joints. Such a multijoint robot is controlled so that the joints can pass a plurality of predetermined taught points. In the motion between the taught points, the joints are controlled based on a trapezoidal velocity pattern. Specifically, each joint has a servomotor for driving the joint, and has a maximum velocity and a maximum acceleration, which are preset according to the characteristics of the servomotor. In the motion between two taught points, the joint is accelerated from the start point, i.e. one taught point, at the maximum acceleration to reach the maximum velocity. When the maximum velocity has been reached, the joint keeps on moving at the maximum velocity. Then, at the point of starting deceleration, the joint is decelerated at the rate of the maximum acceleration to complete the motion to the end point, i.e. the other taught point.

While the velocity pattern of each joint is produced as described above, the individual joints are controlled, in general, so as to simultaneously start motions and simultaneously end the motions, in order that the robot can smoothly move the paths between the taught points. To enable such control, the velocity pattern for each joint is individually set, first, based on the maximum velocity and the maximum acceleration, and then, the velocities and the accelerations of individual joints are reset so that all the joints can simultaneously start motions and simultaneously end the motions, or can simultaneously start acceleration and simultaneously end deceleration. Hereinafter, a method of controlling the individual joints with the velocities and accelerations set as mentioned above, is referred to as “sync control”.

Besides the sync control robots mentioned above, those robots that are moved under non-sync control are known as disclosed, for example, in Japanese Patent Laid-Open No. 6-332510. Specifically, sync control is very effective when a robot is desired to move along a proper path. However, such sync control necessitates the presence of an axis which disables maximum acceleration and deceleration at the rate of the maximum acceleration. Therefore, in the case where high-velocity motion is desired between taught points, the performance of the servomotor at each of the joints cannot be sufficiently exerted, causing loss of time. For this reason, in the technique disclosed in the above literature, all of the joints are adapted to be independently controlled when high-velocity motion is desired between taught points to achieve high-velocity operation.

On the other hand, Japanese Patent Laid-Open No. 11-277468 discloses a technique in which the performance of a drive source is adapted to be maximally utilized, using a method different from the sync control. According to this technique, every time the sampling time period has expired, the position of each joint is calculated based on a predetermined velocity pattern, from the point of expiration of the sampling time to the point of expiration of the subsequent sampling time. Then, with the position of the joint calculated in this way as being a tentative position, a calculation is made as to the drive torque required for the motion to reach the tentative position. If the calculated drive torque is equal to or smaller than a limit value, the tentative position is determined as a commanded position, and then control is effected so that the joint can move to the commanded position in a predetermined unit control time. If the calculated drive torque is larger than the limit value, the point after expiration of a corrected sampling time which is shorter than the above sampling time is determined as being a commanded position based on the predetermined velocity pattern. Then, control is effected so that the joint can move to the commanded position in a predetermined unit control time.

For example, there may be a case where a workpiece is delivered between two robots which are in high-velocity motions. In this case, one robot descends its hand in receiving the workpiece from the other robot, while the other robot ascends its hand after delivering the workpiece. In descending or ascending hands, the sync control permits the hands of the robots to decelerate. Thus, while workpiece delivery has been enabled between two robots moving at different velocity with increasing cycle time, hands of robots are likely to be applied with excessive load.

### SUMMARY OF THE INVENTION

The present invention has been made in light of the circumstances described above, and has as its object to provide a multijoint robot which is able to move its hand a predetermined relationship with another robot, and to provide a method for delivering workpiece, which is able to prevent increase of cycle time when a workpiece is delivered between two moving robots and prevent excessive load that would be applied to the hands of the robots in the delivery of the workpiece between the robots.

In the invention of one aspect, a motion start position and a motion end position is taught to each multijoint robot. The motion between the two positions is divided into a first vector component in a single plane and a second vector component perpendicular to the single plane. In the course of the motion in the direction of the first vector component, the robot is moved in the direction of the second vector component in a timely manner to arrive at the motion end position. Thus, in the case where a workpiece is delivered between two multijoint robots while the two multijoint robots are in motion, teaching of the two positions, i.e. the start and end positions of the delivery motion, to each of the two robots, may enable each of the robots to perform the workpiece delivery motion in a timely manner while the two robots are permitted to move at the same velocity.

In the invention of another aspect, when the hand (i.e., tip end) of a first multijoint robot has arrived at a first predetermined position in the direction of the first vector component, a second multijoint robot is permitted to start motion. Then, when the hand of the first multijoint robot has arrived at a second predetermined position, the hand of the first multijoint robot starts moving in the direction of the second vector component. Thus, the first multijoint robot can be readily moved, while having a predetermined relationship with the second multijoint robot.

In the invention of another aspect, a first multijoint robot starts moving in the direction of a first vector component when a second multijoint robot has been detected as having arrived at a predetermined position. Then, upon arrival at a predetermined position in the direction of the first vector component, the first multijoint robot starts moving in the direction of a second vector component. Thus, the first multijoint robot can be moved at the same velocity as the second multijoint robot, while having a predetermined relationship with the second multijoint robot.

In the invention of another aspect, a workpiece held by a first multijoint robot, among two multijoint robots, is delivered to a second multijoint robot. In this case, when the hand of the first multijoint robot clamping the workpiece has arrived at a first predetermined position in a first plane, the fact of the arrival is notified to the second multijoint robot via a communicating means. When the first robot has moved to a second predetermined position, the clamping of the workpiece is released. The first robot then starts moving in the direction perpendicular to the first plane. On the other hand, upon reception of the arrival notification of the first robot to the first predetermined position, via the communication means, the second robot to be delivered with the workpiece starts moving in the same direction as the moving direction of the first robot in a second plane parallel to the first plane in which the first robot is in motion. Upon arrival at a predetermined position in the second plane, the second robot starts moving in a specific direction perpendicular to the second plane, that is, a direction toward the first plane in which the hand of the first robot is in motion. The second robot can clamp the workpiece during the period from the point when the hand of the second robot has arrived at the first plane and has started to move at the same velocity as that of the hand of the first robot, to the point when the hand of the first robot has arrived at the second predetermined position. Thus, the workpiece can be delivered between the two multijoint robots while the two multijoint robots move at the same velocity.

### BRIEF DESCRIPTIONS OF THE DRAWINGS

In the accompanying drawings:

FIG. 1 is a perspective view illustrating two multijoint robots;

FIG. 2 is a block diagram illustrating a control configuration of a robot;

FIG. 3 is an illustration indicating a velocity pattern;

FIG. 4 is a perspective view illustrating a vector division;

FIG. 5A is a schematic diagram illustrating a workpiece delivery motion between a first robot and a second robot, according to an embodiment of the present invention;

FIG. 5B is a workpiece delivery motion program for the first robot, according to the embodiment;

FIG. 5C is a workpiece delivery motion program for the second robot, according to the embodiment;

FIG. 6 is a flow diagram illustrating the contents of teaching;

FIG. 7 shows velocity pattern diagrams, in which (A) is a velocity pattern diagram of a first vector component/direction for the first robot in the workpiece delivery motion, (B) is a velocity pattern diagram of a second vector component/direction for the first robot in the workpiece delivery motion, (C) is a velocity pattern diagram of a first vector component/direction of the second robot in the workpiece delivery operation, and (D) is a velocity pattern diagram for a second vector component/direction of the second robot in the workpiece delivery motion; and

FIG. 8 shows various schematic diagrams illustrating conditions of the first and second robots at points A to D, respectively, indicated in FIG. 7.

### DETAILED DESCRIPTION OF THE PREFERRED EMBODIMENTS

With reference to the accompanying drawings, a robot system according to an embodiment of the present invention will now be described. The robot system of the present embodiment employs a multijoint robot and a workpiece delivery method.

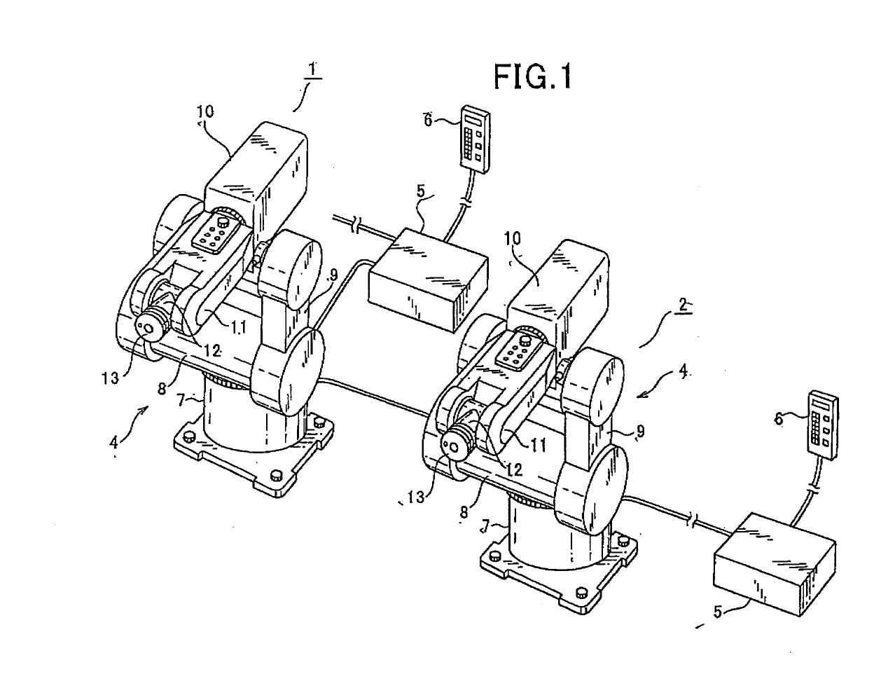

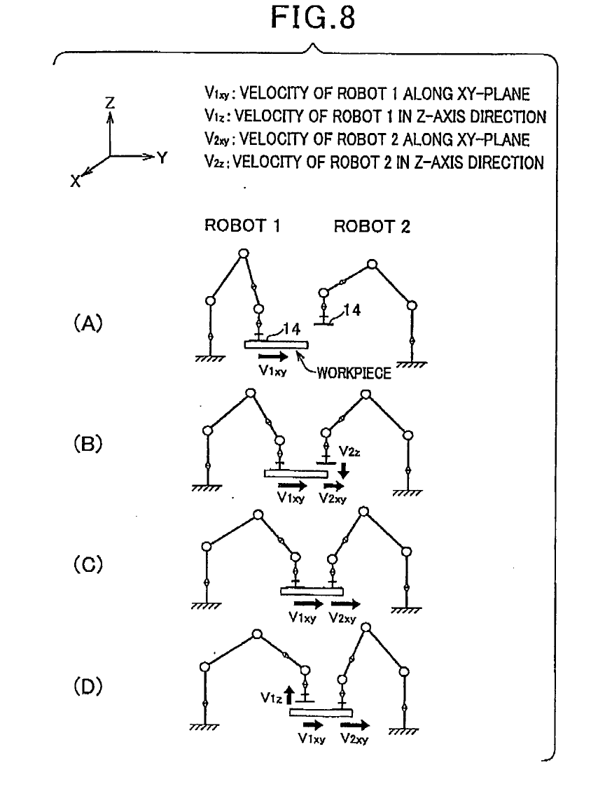

FIG. 1 shows a robot system according to the present embodiment. In this robot system, two multijoint type of robots 1 and 2 (simply referred to as multijoint robots or robots) are placed with a proper space given therebetween. Of the two robots 1 and 2, a first robot 1 is in charge of clamping (gripping) a workpiece 3 (see FIG. 8) that has finished a pre-work process and delivering it toward a place where a post-work process is carried out. The second robot 2 is in charge of receiving the workpiece 3 from the first robot 1 to deliver it to the post-work process.

FIG. 1 is a perspective view illustrating the two multijoint robots 1 and 2.

As shown in FIG. 1, the first and second robots 1 and 2 have the same configuration. Each of the robots 1 and 2 includes a robot unit 4, a control unit 5 and a teaching pendant 6. The robot unit 4 is of a six-axis multijoint type, for example, and includes: a base 7 fixed to the floor; a shoulder 8 supported by the base 7 so as to be able to swivel in the horizontal direction; a lower arm 9 supported by the shoulder 8 so as to be pivotally movable in the vertical direction; a first upper arm 10 supported by the lower arm 9 so as to be pivotally movable in the vertical direction; a second upper arm 11 supported by the tip end portion of the first upper arm 10 so as to be able to swivel; a wrist 12 supported by the second upper arm 11 so as to be pivotally rotatable in the vertical direction; and a flange 13 supported by the wrist 12 so as to be rotatable (be able to swivel). The shoulder 8, the lower arm 9, the first and second upper arms 10 and 11, the wrist 12 and the flange 13, as well as the base 7, function as links in the robot. A hand 14 (see FIG. 8), which clamps (grips) and unclamps (releases) the workpiece 3, is attached to the flange 13 which is the end link.

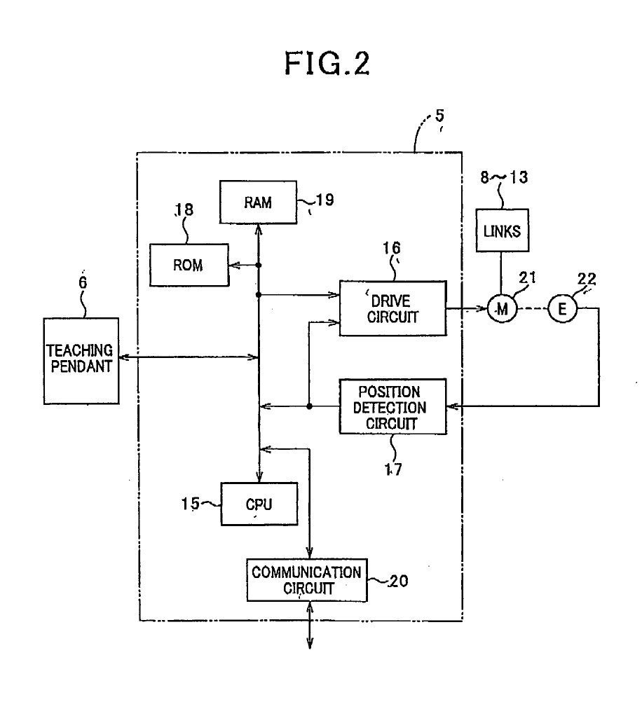

As shown in FIG. 2, the control unit 5 includes a CPU 15 as a controlling means, a drive circuit 16, and a position detection circuit 17 as a position detecting means. The CPU 15 is connected to: an ROM 18 as a storing means which stores a robot language, for example, for preparing a system program and a motion (movement) program of the robot as a whole; an RAM 19 for storing the motion program, for example, of the robot 1 or 2; and a communication circuit 20 as a communicating means which communicates with the teaching pendant 6 used for teaching motion and with other robots to obtain information on the current positions of the other robots.

The position detection circuit 17 is configured to detect the positions of the links 8 to 13 except the base 7. A rotary encoder 22 serving as a position sensor is connected to the position detection circuit 17. The encoder 22 is provided at a motor 21 that is a drive source for a joint shaft (joint) which leads the motion of each of the links 8 to 13. In response to a signal from the rotary encoder 22, the position detection circuit 17 detects an angle for the link concerned, that is: a swiveling angle of the shoulder 8 for the base 7; a pivotal angle of the lower arm 9 for the shoulder 8; a pivotal angle of the first upper arm 10 for the lower arm 9; a swiveling angle of the second upper arm 11 for the first upper arm 10; a pivotal angle of the wrist 12 for the second upper arm 11; or a swiveling angle of the flange 13 for the wrist 12. The individual detected angles, i.e. information on the detected positions, are given to the CPU 15 and the drive circuit 16. In FIG. 2, the motor 21 and the rotary encoder 22 are solely indicated, however, each of the links 8 to 13 except the base 7 is practically provided with its own motor 21 and its own rotary encoder 22. In other words, a plurality of motors 21 and rotary encoders 22 are provided.

The drive circuit 16 compares a commanded angle given by the CPU 15 with the current angle given by the position detection circuit 17, and supplies current corresponding to the difference to the motor 21 concerned to drive the motor 21. Thus, the center portion of the flange 13, that is, the center portion of the tip end (i.e., hand) of the robot, moves along the locus as determined by the motion program and carries out the motion of assemble parts, for example.

The motion program has a record of parameters for every motion, which parameters include a motion end position, velocity (speed) factor, and acceleration/deceleration factor. Among the parameters, the velocity and acceleration/deceleration factors are determined, based on the rates of the maximum velocity and acceleration/deceleration of the motion, respectively, to the tolerant maximum velocity and tolerant maximum acceleration/deceleration of the motor 21 concerned. The tolerant maximum velocity and tolerant maximum acceleration/deceleration are determined for every motor 21, considering the performance of the motor 21, so that the load torque of the motor 21 may not exceed the tolerant maximum torque, for example.

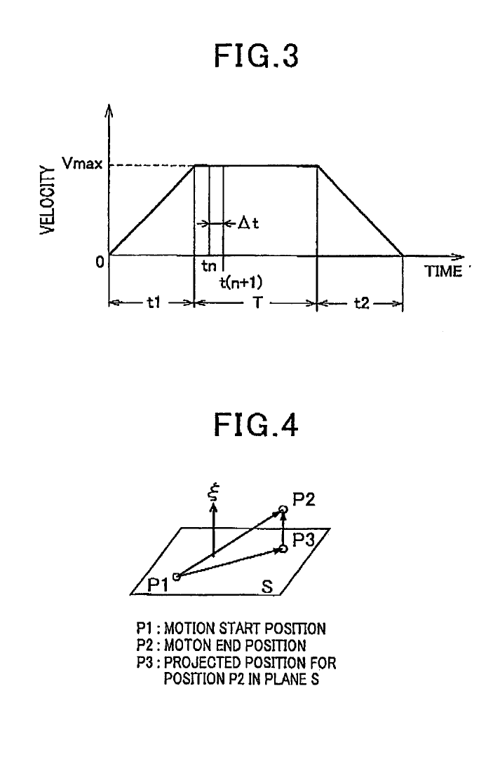

The CPU 15 is adapted to determine a velocity pattern from the parameters recorded in the motion program based, for example, on a trapezoidal pattern. The CPU 15 then calculates the angle of the joint for every expiration of certain time, based on the velocity pattern. The calculated angle is then given to the drive circuit 16, in the form of an angle command value. Specifically, as shown in FIG. 3, the trapezoidal velocity pattern consists of an acceleration stage “t1”, a constant velocity stage “T”, and a deceleration stage “t2”. From the point of starting motion, for every expiration of a predetermined sampling time Δt, a calculation is made to obtain a velocity at the subsequent sampling point (corresponding to the point after expiration of the sampling time Δt), with the expired point as the current time point. The calculated value is then multiplied by the sampling time. The value obtained in this way is sequentially added, so that the angle for each joint can be obtained for every expiration of the sampling time, from the start to the end of the motion. By giving each value as an angle command value to the drive circuit 16, each joint can be moved according to the velocity pattern.

Then, a calculation is made as to the position of each link from the point of expiration of a sampling time to the point of expiration of the subsequent sampling time. Then, with the position at the point of expiration of the subsequent sampling time as being a tentative position, the drive torque required for the motion to the tentative point is calculated. If the calculated drive torque is equal to or smaller than a limit value, the tentative position is determined as a commanded point. Thus, control is effected so that each link can be moved to the commanded point in a predetermined unit control time. If the calculated drive torque is larger than the limit value, the position after expiration of a corrected sampling time which is shorter than the above sampling time is determined as being a commanded position based on the predetermined velocity pattern. Then, control is effected so that each fink can be moved to the commanded position in a predetermined unit control time. In this way, the motors 21 of the individual links 8 to 13 can be controlled so as not to have torque exceeding the maximum torque.

Teaching to each of the robots 1 and 2, for storing contents of is work to be performed by the robot unit 4 is carried out using the teaching pendant 6. Specifically, teaching is carried out by moving the hand 14 to a plurality of desired target positions and allowing the hand 14 to take desired postures at the target positions, using the teaching pendant 6. The RAM 19 of the control unit 5 stores the target positions and postures of the hand 14 set by the teaching, i.e. the target positions and postures of the flange 13, as well as the positions and postures of the links 8 to 13 for having the flange 13 moved to the target positions and taken the postures.

The present embodiment is so configured that, when target positions P1 and P2 are taught, a vector division mode is set, in addition to the normal mode for actuating the tip end (i.e., hand) of the robot from one target position P1 to the other target position P2. As shown in FIG. 4, in the vector division mode, the motion of the tip end of the robot from one target position P1 to the other target position P2 is divided into a first vector component P1→P3 in a predetermined single plane and a second vector component P3→P2 in a specific direction ξ perpendicular to the single plane. By properly setting the motion timing of the first and second vector components P1→P3 and P3→P2, the tip end (i.e., hand) of the robot can be actuated for the motion in the direction of the first vector component P1→P3 according to the trapezoidal velocity pattern, and at the same time can be actuated for the motion in the direction of the second vector component P3→P2 also according to the trapezoidal velocity pattern. In the case where the moving distance is short, the actual pattern will be a triangular velocity pattern having no constant-velocity process.

In the vector division mode, the motion of the tip end (i.e., hand) of the robot in the direction of the first vector component is termed a “sync planar motion” because the two vector components perpendicular to each other in a plane are controlled so that acceleration and deceleration can be simultaneously perform. In this regard, a plane S is termed a “sync plane”. Further, the motion of the tip end of the robot in the specific direction ξ perpendicular to the sync plane S, i.e. the direction of the second vector component, is termed a “non-sync vector relative motion”. This is because, from the point of starting the motion in the direction of the second vector component, no control is effected so that the acceleration and deceleration in the sync plane can be performed simultaneously with the motion in the second vector component.

As mentioned above, in the work of the first and second robots 1 and 2, the first robot 1 clamps (grips) the workpiece 3 finished with the pre-work process and moves toward the post-work process, and the second robot 2 receives the workpiece 3 from the first robot and conveys the workpiece 3 toward the post-work process. Hereinafter is explained the contents of the delivery motion of the workpiece 3.

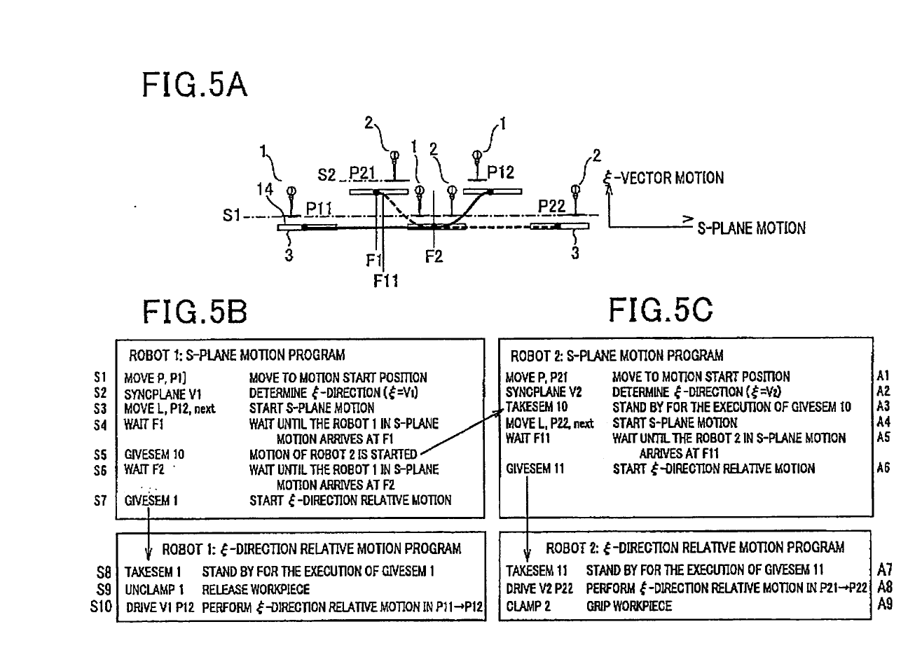

Specifically, the first robot (one multijoint robot) 1 grips the workpiece 3 at a motion start position P11 indicated in FIG. 5A. Then, the tip end (i.e., hand) of the first robot 1 starts linear motion from the position P11 in a single plane, e.g. in a horizontal first plane S1. The velocity of the horizontal linear motion is determined based on the trapezoidal velocity pattern. That is, the velocity of the horizontal linear motion is accelerated to a predetermined level, and upon reaching the predetermined level, is turned to a constant-velocity motion of the predetermined level.

On the other hand, a motion start position P21 of the second robot (the other multijoint robot) 2 that receives the workpiece 3 from the first robot 1, is set at a position higher than the position P11 of the first robot 1, for example. When the tip end (i.e., hand) of the first robot 1 has reached a first predetermined position F1 in the plane S1, the second robot 2 starts linear motion of a tip end (i.e., hand) of the second robot 2 in a second plane S2 which is parallel to the first plane S1. The direction of the linear motion of the tip end of the second robot 2 is the same as the direction of the horizontal motion of the first robot 1. The velocity of the linear motion is also determined based on the trapezoidal velocity pattern. In the trapezoidal velocity patterns of the robots 1 and 2, the velocities in the constant-velocity processes are set to be the same.

Upon reaching a predetermined position F11 in the plane S2, the tip end (i.e., hand) of the second robot 2 starts moving perpendicularly downward toward the linear motion plane S1 of the first robot 1, in addition to the horizontal linear motion. Then, when the tip end of the second robot 2 has reached the plane S1 for linear motion at the same velocity as that of the tip end of the first robot 1, the second robot 2 grips the workpiece 3 in a predetermined period up until the point when the tip end of the first robot 1 reaches the subsequent second predetermined position F2.

When the tip end of the first robot 1 has reached the second predetermined position F2, the first robot 1 releases the clamping of the workpiece 3 and starts perpendicularly upward motion, in addition to the linear motion, so as to be upwardly distanced from the plane S1. Then, the first robot 1 stops when its tip end has reached a motion end position P12 to complete the workpiece delivery motion. Meanwhile, the second robot 2 continues the linear motion in the plane S1 and stops at the point when the tip end has reached an motion end position P22 to complete the workpiece delivery motion.

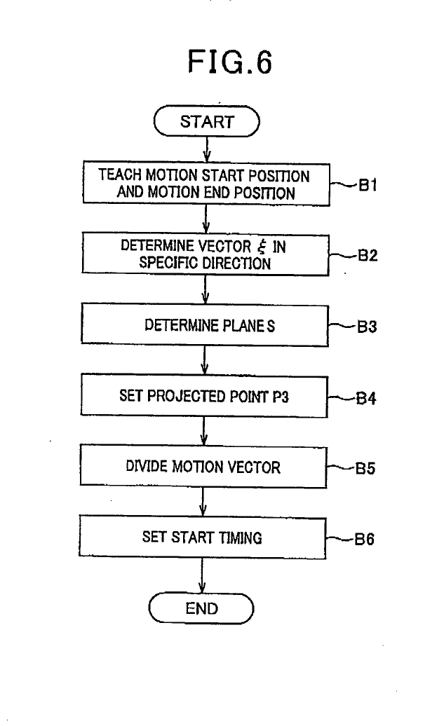

The teaching for carrying out the workpiece delivery motion described above is carried out as follows. First, both of the robots 1 and 2 are set to the vector division mode. Then, using the teaching pendant 6 of the first robot 1, the motion start position P11 and the motion end position P12 of the tip end of the first robot 1 are taught. At the same time, using the teaching pendant 6 of the second robot 2, the motion start position P21 and the motion end position P22 of the tip end of the second robot 2 are taught (position teaching means: step B1 of FIG. 6).

Subsequently, the vector ξ in the non-sync direction is set vertically upward using the teaching pendant 6 of the first robot 1. Also, the vector ξ in the non-sync vector relative motion direction (specific direction) is set vertically downward, using the teaching pendant 6 of the second robot 2 (specific direction setting means: step B2). Then, the CPUs 15 of both of the robots 1 and 2 determine the sync planes S1 and S2 as being horizontal planes (first and second sync planes S1 and S2) that are perpendicular to the vector ξ in the specific direction and contain the motion start positions P11 and P21 (sync plane setting means: step B3).

The CPUs 15 of both of the robots 1 and 2 determine projection points P13 and P23 of the motion end positions P12 and P22, respectively, on the planes S1 and S2 (sync planar motion end position setting means: step B4). Then, the CPU 15 of the robot 1 divides a motion vector P11→P12 into a first vector component P11→P13 in the plane S1 and a second vector component P13→P12 in the specific direction perpendicular to the plane S1 (vector dividing means: step B5). Similarly, the CPU 15 of the robot 2 divides a motion vector P21→P22 into a first vector component P21→P23 in the plane S2 and a second vector component P23→P22 in the specific direction perpendicular to the plane S2 (vector dividing means: step B5).

Then, by means of the teaching pendant 6 of the first robot 1, motion start timing in the direction of the first vector component P11→P13 is set to a point after expiration of a predetermined time, for example, from the end of the pre-process work. At the same time, setting is made so that, at the point when the tip end of the robot 1 has arrived at the first predetermined position F1, the fact of this arrival is notified to the second robot 2 via the communication circuit 20. Further, motion start timing in the direction of the second vector component P13→P12 is set to a point when the tip end of the robot 1 has arrived at the second predetermined position F2.

Further, by means of the teaching pendant 6 of the second robot 2, motion start timing of the tip end of the robot 2 in the direction of the first vector component P21→P23 is set to a point of receiving the arrival notification of the first robot 1 to the first predetermined position F1. At the same time, motion start timing in the direction of the second vector component P23→P22 is set to a point when the tip end of the robot 2 has arrived at the predetermined position F11 in the plane S2 (motion start timing setting means: step B6).

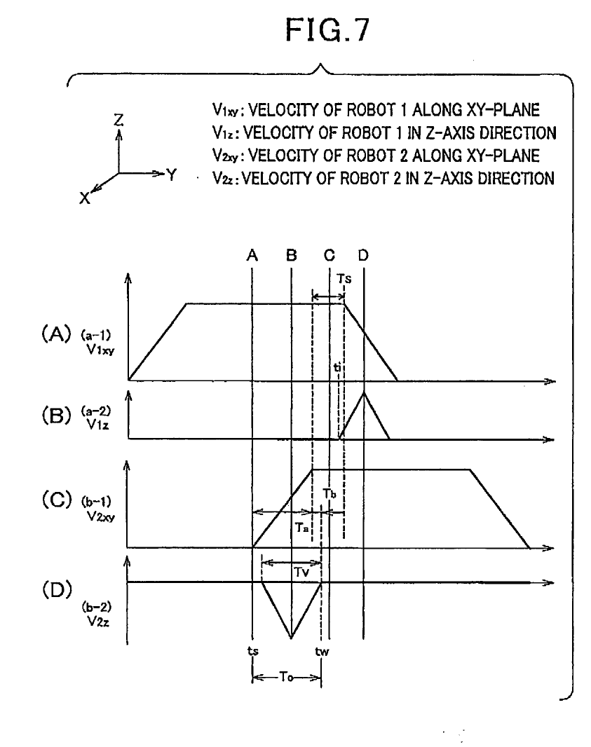

As shown in (A) to (D) in FIG. 7, the position F1 is determined so as to fall within an acceleration process time “Ta” of the second robot 2. Specifically, the position F1 is determined in such a way that, within the time “Ta”, the tip end of the second robot 2 can approach the first robot 1 sufficient enough to clamp the workpiece held by the first robot 1, and that the velocity of the second robot 2 in the first vector component P21→P23 can turn to the same as the velocity in the first vector component P11→P13 of the first robot 1. Such a position setting can be calculated based on the trapezoidal velocity pattern of the horizontal motion.

The position F11 is set as follows. Specifically, the delivery of the workpiece 3 may only have to be performed while the tip ends of the robots 1 and 2 move at the same velocity (time “Ts” in FIG. 7), that is, by timing “ti” when the tip end of the first robot starts moving in the direction of the second vector component P13→P12. To this end, time “Tv”, which is the time from the start of the downward motion of the tip end of the second robot 2 to the arrival at the plane S1, is calculated, first, based on the trapezoidal velocity pattern (actually, triangular velocity pattern) of the vertical motion. Then, a predetermined point is determined within the time “Ts” in which the tip ends of the robots 1 and 2 move at the same velocity. For example, the predetermined time may be set at a point “tw” (before the point “ti”) that is the point after expiration of time “Tb” since the velocity of the tip end of the second robot 2 has reached the same level as that of the tip end of the first robot 1. Then, an amount of travel from the start of the horizontal motion to the expiration of (Ta+Tb−Bv) time is calculated based on the trapezoidal velocity pattern. Thus, the position F11 can be calculated by adding the calculated amount of travel to the horizontal motion start position P21.

As described above, the motion programs for both of the robots 1 and 2 are set as shown in FIGS. 5B and 5C. Each of these motion programs consists of a sync motion (S plane motion) program and non-sync motion (the ξ-direction relative motion) program.

Hereinafter are explained the motions of the robots 1 and 2 according to the motion programs shown in FIGS. 5B and 5C. The following motions are controlled by the CPUs 15. Upon completion of the previous delivery motion of the workpiece 3, the tip ends of the robots 1 and 2 move back from the motion end positions P12 and P22 to the motion start positions P11 and P21 (steps S1 and A1), respectively. Then, the specific directions R are determined (steps S2 and A2). After that, the first and second robots 1 and 2 go into a standby state.

After expiration of a predetermined time since the completion of the pre-process work (the completion of the work is informed from a work management computer through communication), the tip end of the first robot 1 starts linear motion in the plane S1 from the motion start position P11 toward the direction of the first vector component P11→P13 (first vector direction motion starting means: step S3). The linear motion of the tip end of the first robot 1 is performed based on the trapezoidal velocity pattern. Thus, as shown in FIG. 7(A), the linear motion is accelerated up to a predetermined velocity. Upon reaching the predetermined velocity, the tip end of the robot 1 moves at a predetermined constant velocity, and is then controlled so as to be decelerated (first motion controlling means).

When the tip end of the first robot 1 has arrived at the predetermined position F1 during the constant-velocity motion, the first robot 1 then sends a notification signal to the second robot 2 notifying the arrival of the robot 1 at the predetermined position F1 (motion start commanding means: steps S4 and S5). Upon reception of the notification signal, the second robot 2 starts linear motion from the motion start position P21 along the direction of the first vector component P21-+P23 (steps A3 and A4). This point is indicated by “A” in (A) to (D) in FIG. 7, and the states of the robots 1 and 2 at this point are shown in FIG. 8(A).

Then, when the tip end of the second robot 2 has arrived at the predetermined position F11, a command for starting the ξ-direction relative motion is issued (second vector direction motion starting means: steps A5 and A6). Thus, the second robot 2 starts moving in the direction of the second vector component P23→P22, keeping the trapezoidal velocity pattern in the direction of the first vector component P21→P23 (keeping the acceleration state, in the present embodiment). Although the motion velocity in the direction of the second vector component P23→P22 is based on the trapezoidal velocity pattern, the velocity pattern actually results in a triangular velocity pattern because the distance of the motion is short regarding the component P23→P22. The time point when the second robot 2 is in the process of moving in the direction of the second vector component P23→P22 is indicated by “B” in FIGS. 2A to 2D, and the states of the robots 1 and 2 at this point are shown in FIG. 8(B).

In the course of the motion in which the tip end of the second robot 2 moves in the direction of the second vector component P23→P22, the motion velocity of the tip end of the robot 2 in the first vector component P21→P23 turns to the same as that of the tip end of the first robot 1 in the direction of the first vector component P11→P13. From this point onward, the tip end of the robot 2 moves at the same motion velocity as that of the tip end of the robot 1 in the direction of the first vector component P11→P13. Immediately after this, the tip end of the robot 2 arrives at the plane S1 for the linear motion of the tip end of the robot 1 and stops the motion in the direction of the second vector component P23→P22 (second motion controlling means).

As a result, while moving in the direction of the first vector component P21→P23 at the same velocity as that of the tip end of the first robot 1, the tip end of the robot 2 arrives at the motion plane S1 of the tip end of the robot 1. Concurrently with the arrival at the plane S1, the second robot 2 grips the workpiece 3 using the hand 14, which workpiece is gripped by the first robot 1. Thus, the workpiece 3 is gripped by both the robots 1 and 2, but no excessive force is applied to the workpiece 3 and the hands 14 of the robots 1 and 2, for the tip ends of both of the robots 1 and 2 are in motion at the same velocity. The point immediately after the workpiece 3 has been held by both of the robots 1 and 2 is indicated by “C” in FIG. 7, and the states of the robots 1 and 2 at this point are shown in FIG. 8(C).

When the tip end of the first robot 1 has arrived at the second predetermined position F2, the robot 1 releases (unclamps) the workpiece 3, and the tip end thereof starts motion in the direction of the second vector component P13→P12 (second vector direction motion starting means: steps S6 to S10). Thus, the tip end of the robot 1 is controlled so as to move upward at the velocity based on the trapezoidal velocity pattern to arrive at the motion end position P12 (second motion controlling means), whereby the workpiece delivery motion is ended. The tip end of the robot 2, on the other hand, keeps moving in the direction of the first vector component P21→P13 in the state of clamping the workpiece 3. When the tip end of the robot 2 has arrived at the motion end position P22, the workpiece delivery motion is ended (first motion controlling means).

During the workpiece delivery motion described above, for every expiration of the sampling time, the robots 1 and 2 each calculate the positions of the respective motors 21 (joints) in the period from the expiration of the sampling time to the expiration of the subsequent sampling time. Then, with each position after the expiration of the subsequent sampling time as being a tentative position, the robots 1 and 2 each calculate the drive torque required for the motion to the tentative position. If the calculated drive torque is equal to or smaller than a limit value, the tentative position is determined as being a commanded position, and then each motor 21 is controlled so as to be moved to the commanded position in a predetermined unit control time.

Under such control, if the calculated drive torque is larger than the limit value, the position after expiration of a corrected sampling time which is shorter than the above sampling time is determined as being a commanded position based on the predetermined velocity pattern. Then, control is effected so that each motor 21 can move to the commanded position in a predetermined unit control time. In this way, the motors 21 can be controlled so as not to have torque exceeding the limit value.

As described above, if the calculated drive torque is larger than the limit value, the position after expiration of the corrected sampling time which is shorter than the above sampling time is determined as being a commanded position. Accordingly, when both of the first and second robots has simultaneously held a workpiece, in particular, the velocity of the tip end of the robot (first robot), in which the corrected sampling time has been set, will be delayed, disabling the motion conducted at the same velocity as that of the tip end of the other robot (second robot). In this case, the first robot notifies the second robot of the corrected sampling time via communication. The second robot that has received the notification of the corrected sampling time is adapted to set a commanded position based on the notified corrected sampling time, even if the drive torque of each motor in the second robot does not exceed the limit value. In this way, both of the first and second robots are able to move at the same velocity, without allowing each of the motors to generate excessive drive torque. As a matter of course, the maximum acceleration and the maximum velocity may be preset in the trapezoidal velocity pattern so that no excessive drive torque is generated in each of the motors.

The present invention may be embodied in several other forms without departing from the spirit thereof. For example, the motions of the two robots 1 and 2 are not limited to the delivery of the workpiece 3. The embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. A multijoint robot having a multijoint link and a hand attached to the link, comprising:
motion separating means for separating, in terms of vectors, a motion of the hand into a first motional vector component along a given plane and a second motional vector component along a plane perpendicular to the given plane; and
control means for controlling a motion of the hand based on an operation timing of the hand to be set on the first motional vector component and the second motional vector component.

2. The multijoint robot of claim 1, wherein
the present robot moves in association with a further robot having a multijoint arm and a hand linked to the arm and
the control means comprises
first motion control means for controlling the motion of the hand in a direction along the first motional vector component thereof so that the hand moves via a first predetermined position to a second predetermined position at a constant velocity, the first and second predetermined positions residing in the direction along the first motional vector component;
command means for commanding the further robot to start to move the hand thereof when the hand of the present robot arrives at the first predetermined position; and
second motion control means for controlling the motion of the hand of the present robot in a direction along the second motional vector component thereof so that the hand of the present robot is made to start to move in the direction along the second motional vector component, whereby the hand of the present robot moves during which a given spatial positional relationship is kept between both hands of the present robot and the further robot.

3. The multijoint robot of claim 1, wherein
the present robot moves in association with a further robot having a multijoint arm and a hand linked to the arm and
the control means comprises
first motion control means for controlling the motion of the hand of the present robot so that the hand thereof is made to start to move in a direction along the first motional vector component, when it is detected that the hand of the further robot arrives at a predetermined position in a plane which is in parallel with the given plane;
second motion control means for controlling the motion of the hand of the present robot so that the hand thereof is made to start to move in a direction along the second motional vector component, when the hand of the present robot arrives at a predetermined position in a plane along the first motional vector component,
wherein during a period of time in which the hand of the further robot moves from the given plane to the plane parallel with the given plane, a motion velocity of the hand of the present robot in the direction along the first motional vector component is the same as a motion velocity of the hand of the further robot.

4. A method of delivering a workpiece between two multijoint robots position-communicably connected to each other via a communication means, in which, of the two robots, a first robot clamping the workpiece hands the workpiece over to a second robot, each robot having a multijoint arm and a hand linked to the arm, the method comprising:
allowing the first robot to
i) move the hand thereof via a first predetermined position to a second predetermined position at a constant velocity, the first and second predetermined positions residing a given plane,
ii) notify the second robot of the arrival of the hand of the first robot at the first predetermined position via the communication means when the hand of the first robot arrives at the first predetermined position, and
iii) unclamp the workpiece from the hand thereof and start to move along a specified direction perpendicular to the given plane, when the hand of the first robot arrives at the second predetermined position; and
allowing the second robot to
iv) start to move along a further plane in parallel with the given plane in the same direction as a moving direction of the hand of the first robot, when it is notified from the first robot via the communication means that the hand of the first robot has arrived at the predetermined first position,
v) start to move along a specified direction perpendicular to the further plane and toward the given plane along which the hand of the first robot moves, when the hand of the second robot arrives at a predetermined position in the further plane, and
vi) clamping the workpiece during a period of time from a first timing when the hand of the second robot arrives at the given plane and starts to move at a moving velocity equal to a moving velocity of the hand of the first robot to a second timing at which the hand of the first robot arrives at the second predetermined position.
